(19) United States
(12) Patent Application Publication
(10) Pub. No.: US 2023/0153751 A1
(43) Pub. Date: May 18, 2023

(54) GENERATING CLUSTERS OF GEOGRAPHIC REGIONS FOR EVALUATION OF DIFFERENT CONDITIONS BASED ON ACTIVE SHOPPERS FULFILLING ORDERS IN DIFFERENT GEOGRAPHIC REGIONS

(71) Applicant: Maplebear Inc. (dba Instacart), San Francisco, CA (US)

(72) Inventors: Konrad Gustav Miziolek, San Francisco, CA (US); Nicholas William Sturm, Denver, CO (US)

(21) Appl. No.: 17/530,421

(22) Filed: Nov. 18, 2021

(51) Int. Cl. G06Q 10/08; G06Q 30/06

(52) U.S. Cl. CPC G06Q 10/087; G06Q 30/0635; G06Q 30/0639

(57) ABSTRACT

An online concierge system evaluates different parameters for order fulfillment in different geographic regions and evaluates order fulfillment in the different geographic regions to assess the different parameters. However, shoppers may fulfill orders in different geographic regions, causing spillover where order fulfillment by a shopper is affected by different parameters. To reduce spillover but still obtain a large number of zones for testing, the online concierge system generates a graph of geographic regions, with connections between geographic regions based on shoppers who fulfill orders in different geographic regions. The online concierge system generates a cluster including geographic regions connected to each other with a connection satisfying one or more criteria indicating at least a threshold percentage of shoppers fulfilling orders in each of the connected geographic regions.

### BACKGROUND

This disclosure relates generally to generating clusters of geographic regions for evaluation, and more specifically to accounting for shoppers active in multiple geographic regions when clustering geographic regions.

In current online concierge systems, shoppers (or “pickers”) fulfill orders at a physical warehouse, such as a retailer, on behalf of customers as part of an online shopping concierge service. An online concierge system provides an interface to a customer identifying items offered by a physical warehouse and receives selections of one or more items for an order from the customer. In current online concierge systems, the shoppers may be sent to various warehouses with instructions to fulfill orders for items, and the shoppers then find the items included in the customer order in a warehouse.

To simplify user interaction and to decrease time for shoppers to fulfill orders, an online concierge system often conducts experiments that adjust one or more configuration parameters. The online concierge system uses the adjusted parameters when fulfilling orders identifying locations in certain geographic regions, while using the original parameters when fulfilling orders identifying locations in other geographic regions. By using the modified parameters in certain geographic regions and the original parameters in other geographic regions, the online concierge system can subsequently compare performance between geographic regions with the modified parameters and with the original parameters.

While the use of different parameters in different geographic regions allows an online concierge system to evaluate effects of different parameters on order fulfillment or user interactions, many shoppers fulfilling orders fulfill orders in multiple geographic regions during a common time interval. This operation of shoppers in multiple geographic regions increases complexity for the online concierge system to evaluate effects of changes to parameters on overall performance, as shoppers fulfilling orders in geographic regions in which different parameters are used causes effects of parameters for one geographic region to impact performance in the other geographic region, making it increasingly difficult to isolate how changes to one or more parameters impact shopper performance or online concierge system performance.

Additionally, the spillover effect of shoppers fulfilling orders in different geographic regions with different parameters increases an amount of time for the online concierge system to identify effects of different parameters on shopper performance. This causes online concierge systems to extend an amount of time that different parameters are used in different geographic regions, so an online concierge system can obtain sufficient data about performance of the different parameters to assess effects of the different parameters. Such an increased amount of time using different parameters in different geographic regions, which can impair order fulfillment by prolonging an amount of time that parameters impairing online concierge system performance are used in certain geographic regions to obtain sufficient data for evaluating effects of the parameters on online concierge system performance.

### SUMMARY

An online concierge system identifies multiple geographic regions, with each geographic region including one or more locations. In various embodiments, the online concierge system identifies a geographic region based on a location, with a geographic region including points within a threshold distance of a location. In some embodiments, each geographic region corresponds to a ZIP code. The online concierge system may identify geographic regions using any suitable method in various embodiments.

As the online concierge system receives orders from users, shoppers fulfill the received orders. A shopper fulfills an order by obtaining one or more items included in an order from a warehouse and delivering the one or more items to a location identified by the order. When a shopper fulfills an order, the online concierge system stores information identifying a time when the shopper fulfilled the order and a location identified by the order in association with an identifier of the order and an identifier of the shopper. The online concierge system may store any additional information in association with the identifier of the order and the identifier of the shopper, in various embodiments.

From the stored information identifying fulfillment of orders by shoppers, the online concierge system identifies one or more geographic regions in which a shopper fulfilled orders during a time interval. In various embodiments, the time interval is a threshold amount of time prior to a current time, while in other embodiments, the time interval is any suitable duration identified by the online concierge system. For example, the online concierge system selects a geographic region and identifies shoppers for whom information is stored indicating a shopper fulfilled at least one order having a location within the selected geographic region. As another example, the online concierge system determines a geographic region including a location of each order fulfilled during the time interval and stores the determined geographic region for an order in association with the shopper who fulfilled the order. In some embodiments, the online concierge system determines a location of a shopper from location information the online concierge system receives from a client device of the user within a threshold amount of time from a time when the shopper indicated an order was fulfilled and identifies the geographic location including the location information received from the client device of the user in association with the order and the time when the shoppers indicated the order was fulfilled. For example, the online concierge system receives location information from one or more position sensors (e.g., a global positioning system sensor) included in the client device of the shopper. This allows the online concierge system to identify a geographic region for each order fulfilled by a shopper during the time interval, allowing the online concierge system.

From the identified geographic regions in which orders were fulfilled during the time interval, the online concierge system generates a graph having nodes corresponding to geographic regions. In various embodiments, each node in the graph corresponds to a different geographic region and each note has a weight based on a number of shoppers who fulfilled an order in a geographic region corresponding to a node. For example, a node corresponding to a geographic region includes an identifier of the geographic region and a number of shoppers who fulfilled at least one order in the geographic region during the time interval. To determine the weight for a geographic region, the online concierge system identifies orders fulfilled during the time interval for which the geographic region was identified and determines a number of shoppers associated with orders including a location included in the geographic region and fulfilled during the time interval. In various embodiments, the online concierge system 102 determines a number of unique shoppers who fulfilled at least one order having a location included in the geographic region during the time interval.

Additionally, the online concierge system generates connections in the graph between a node corresponding to a geographic region and an additional node corresponding to an additional geographic region in response to one or more shoppers fulfilling orders in the geographic region and in the additional geographic region during the time interval. A connection between the node corresponding to the geographic region and the additional node corresponding to the additional geographic region. Additionally, the connection between the node corresponding to the geographic region and the node corresponding to the additional geographic region has a weight determined from a number of shoppers who fulfilled at least one order in the geographic region during the time interval and fulfilled at least one order in the additional geographic region during the time interval. For example, the weight of a connection between the node corresponding to the geographic region and the additional node corresponding to the additional geographic region is a ratio of a number of unique shoppers who fulfilled at least one order in the geographic region during the time interval and fulfilled at least one order in the additional geographic region to a weight of the node or of the additional node. In an example, the weight of a connection between the node corresponding to the geographic region and the additional node corresponding to the additional geographic region is a ratio of a number of unique shoppers who fulfilled at least one order in the geographic region during the time interval and a minimum of the weight of the node and the weight of the additional node. Hence, the graph includes connections between a pair of nodes in response to one or more shoppers fulfilling orders during the time interval in geographic regions corresponding to each node of the pair. If no shoppers have fulfilled orders in a geographic region and in an additional geographic region, the graph does not include a connection between a node corresponding to the geographic region and an additional node corresponding to the additional geographic region. Hence, the weight of a connection between a node and an additional node provides a measure of an amount of shoppers who fulfilled orders in geographic regions corresponding to both the node and the additional node during the time interval, allowing the weight of the connection to provide a measure of overlapping shoppers who fulfilling orders in multiple different geographic regions during the time interval.

The online concierge system selects a pair of geographic regions and determines whether a weight of a connection between the pair of nodes corresponding to the pair of geographic regions equals or exceeds a threshold value. As the weight of the connection between a node corresponding to a geographic region and an additional node corresponding to an additional geographic region is based on a number or shoppers who fulfilled at least one order in both the geographic region and in the additional geographic region during the time interval, the threshold value allows the online concierge system to specify an amount of overlap of shoppers fulfilling orders in both the geographic region and the additional geographic region. For example, the threshold value specifies a percentage of shoppers who fulfilled orders in both the geographic region and the additional geographic region during the time interval. Higher threshold values correspond to a greater percentage of shoppers fulfilling orders in both the geographic region and the additional geographic region during the time interval.

In response to determining the weight of the connection between the pair of nodes corresponding to the pair of geographic regions equaling or exceeding the threshold value, the online concierge system generates a cluster of geographic regions that includes the pair of nodes. The pair of nodes includes a node corresponding to a geographic region of the pair and an additional geographic region of the pair, so the cluster of geographic regions includes the geographic region and the additional geographic region in response to the connection between the node corresponding to the geographic region and the additional node corresponding to the additional geographic region. Hence, the cluster of geographic regions includes geographic regions where at least a threshold percentage of shoppers fulfilled orders in different geographic locations in the cluster during the time interval.

However, in response to determining the weight of the connection between the pair of nodes corresponding to the pair of geographic regions equaling or exceeding the threshold value, the online concierge system generates a separate cluster for each geographic region of the pair. Hence, when the weight of a connection between a node corresponding to a geographic region and an additional node corresponding to an additional geographic region is less than the threshold value, the online concierge system generates a cluster including the geographic region and a separate cluster including the additional geographic region. This allows the online concierge system to separate the geographic region and the additional geographic region when less than a threshold percentage of shoppers fulfilling orders during the time interval fulfill orders in both the geographic region and in the additional geographic region.

Subsequently, when the online concierge system identifies geographic regions for testing modified parameters for operation, the online concierge system uses the generated clusters. The online concierge system selects a set of parameters and applies the set of parameters to each geographic region included in a cluster selected by the online concierge system, so fulfillment of orders subsequently received by the online concierge system that identify locations within the cluster are subject to the set of parameters. Hence, parameters for a cluster are applied to each geographic region in the cluster. As generation of the clusters accounts for an amount of shoppers who fulfilled orders in multiple geographic regions during a time interval, specifying common parameters for each geographic region in a cluster allows the online concierge system to account for spillover of shoppers across different geographic regions by having common parameters apply to each geographic region in which shoppers are likely to fulfill orders. This mitigates effects on parameter evaluation by the online concierge system caused by shoppers fulfilling orders in geographic regions with different parameters. Additionally, the online concierge system may specify the threshold value to maximize a number of clusters that are generated, which decreases an amount of time for the online concierge system to evaluate performance of different parameters in different geographic regions. This allows the generation of clusters to conserve computational resources of the online concierge system used for maintaining different parameters and accounting for the different parameters when fulfilling orders received from users. Hence, in addition to improving accuracy for evaluating effects of different parameters on order fulfillment, generating clusters of geographic regions allows the online concierge system to reduce an amount of time the online concierge system maintains and selects between different parameters to evaluate effects of different parameters on order fulfillment.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is an example graph identifying relationships between geographic regions based on fulfillment of orders in the geographic regions by shoppers, according to one embodiment.

FIG. 5 is a flowchart illustrating a method for generating one or more clusters of geographic regions based on fulfillment of orders by shoppers in different geographic regions, according to one embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

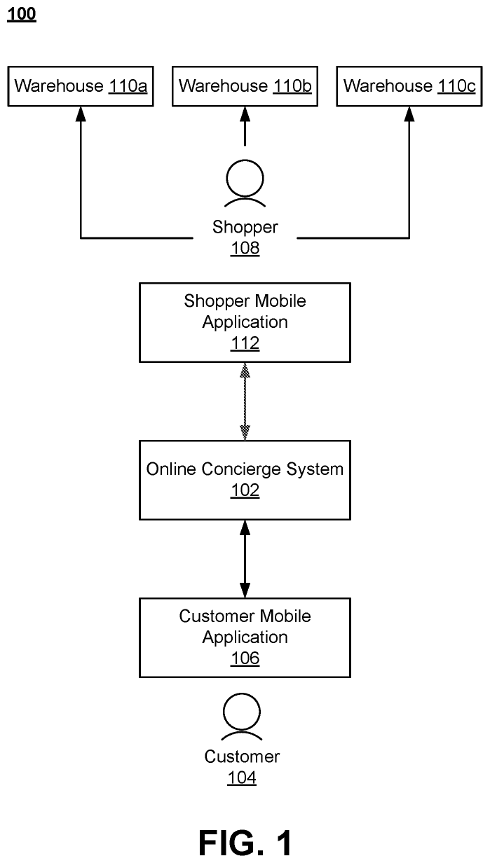

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more shoppers 108. A shopper 108 may be a contractor, employee, or other person (or entity) who is enabled to fulfill orders received by the online concierge system 102. The shopper 108 travels between a warehouse and a delivery location (e.g., the customer's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to customers. Each shopper 108 fulfills an order received from the online concierge system 102 at one or more warehouses 110, delivers the order to the customer 104, or performs both fulfillment and delivery. In one embodiment, shoppers 108 make use of a shopper mobile application 112 which is configured to interact with the online concierge system 102.

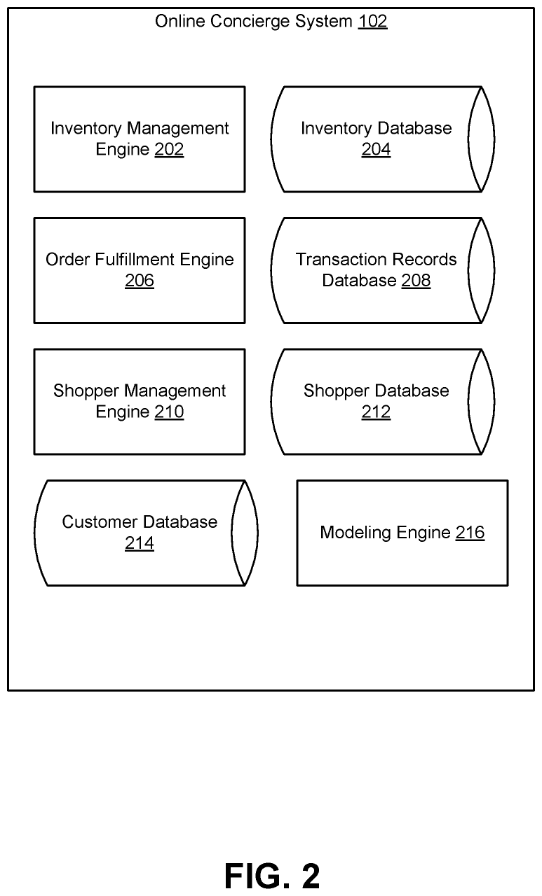

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

In various embodiments, the inventory management engine 202 maintains a taxonomy of items offered for purchase by one or more warehouses 110. For example, the inventory management engine 202 receives an item catalog from warehouse 110 identifying items offered for purchase by warehouse 110. From the item catalog, the inventory management engine 202 determines a taxonomy of items offered by the warehouse 110. Different levels in the taxonomy providing different levels of specificity about items included in the levels. For example, the taxonomy includes different categories for items, with categories in different levels of the taxonomy providing different levels of specificity for categories, with lower levels in the hierarchy corresponding to more specific categories, and a lowest level of the hierarchy identifying different specific items. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with generic item descriptions corresponding to levels within the taxonomy.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a customer 104. Prices set by the order fulfillment engine 206 may or may not be identical to in-store prices determined by retailers (which is the price that customers 104 and shoppers 108 would pay at the retail warehouses). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the customer 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a customer database 214 which stores information describing each customer. This information could include each customer's name, address, gender, shopping preferences, favorite items, stored payment instruments, and so on.

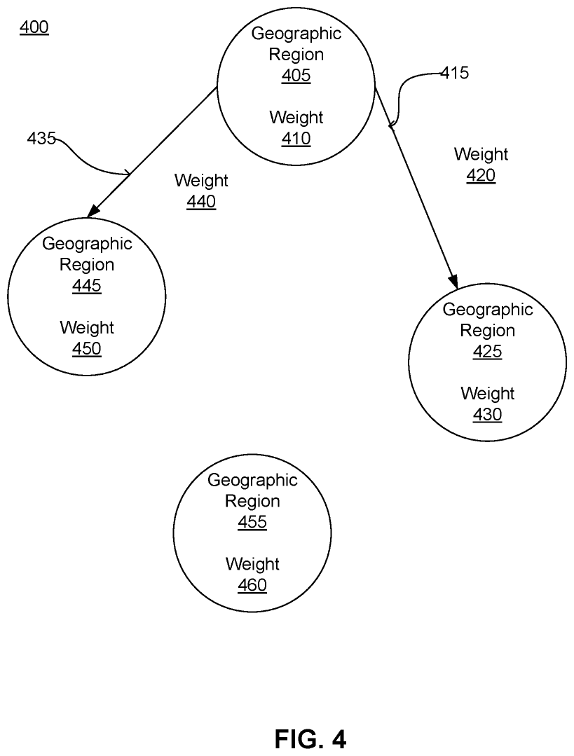

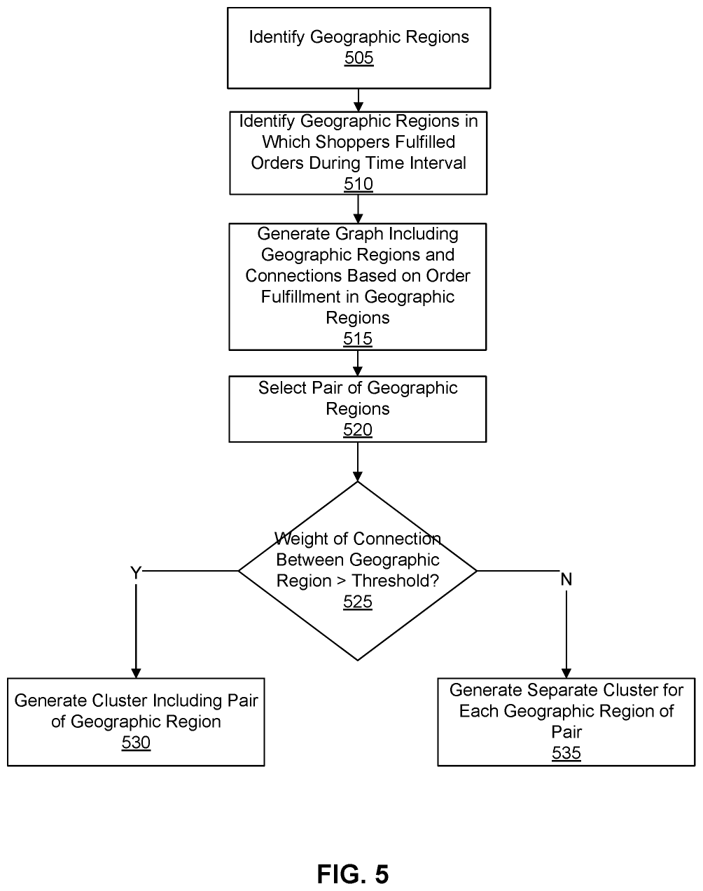

In some embodiments, the order fulfillment engine 206 evaluates different parameters for order fulfillment in different geographic regions in which orders are fulfilled. The order fulfillment engine 206 compares information describing orders fulfillment in geographic regions having different parameters to refine or select parameters that optimize order fulfillment. As shoppers may fulfill orders in different geographic regions, this spillover of shoppers fulfilling orders in different geographic regions increases the complexity of the order fulfillment engine 206 accurately evaluating effects of different parameters on order fulfillment as a shopper fulfilling orders in different geographic regions is affected by different parameters for the geographic regions. As further described below in conjunction with FIGS. 4 and 5, the modeling engine 216 generates clusters of geographic regions that account for frequencies with which shoppers fulfill orders in multiple geographic regions. The order fulfillment engine 206 selects clusters for application of one or more parameters, with each geographic region in a cluster subject to the one or more parameters for the cluster, to reduce a likelihood of shoppers fulfilling orders in geographic regions having different parameters.

The modeling engine 216 generates a graph identifying geographic regions in which orders are fulfilled and connections between geographic regions based on fulfillment of orders in different geographic regions during a common time interval. As further described below in conjunction with FIGS. 4 and 5, the modeling engine 216 leverages information from the transaction records database 208 identifying previously fulfilled orders to generate the graph. When generating the graph, the modeling engine 216 connects a geographic region and an additional geographic region when one or more shoppers fulfilled orders in the geographic region and the additional geographic region during a common time interval. However, in other embodiments, the modeling engine 216 connects the geographic region and the additional geographic region in response to at least a threshold number of shoppers fulfilling an order in the geographic region and an order in the additional geographic region. Further, the graph includes a weight for each geographic region, with a weight for a geographic region based on a number of shoppers who fulfilled an order in the geographic region during a time interval. In some embodiments, the weight is the number of unique shoppers who fulfilled an order in the geographic region. For a connection between a geographic region and an additional geographic region, the modeling engine stores a weight for the connection that is based on a number of unique shoppers who fulfilled an order in the geographic region and fulfilled an order in the additional geographic region during the time interval. In some embodiments, the weight for a connection is a ratio of the number of unique shoppers who fulfilled an order in the geographic region and fulfilled an order in the additional geographic region during the time interval to a weight of one of the geographic region and the additional geographic region, as further described below in conjunction with FIGS. 4 and 5. As further described below in conjunction with FIG. 5, the modeling engine 216 generates a cluster including a geographic region and an additional geographic region based on a weight of a connection between the geographic region and the additional geographic region satisfying one or more criteria. This allows the modeling engine 216 to cluster geographic regions together when there is a threshold amount of overlap between fulfillment of orders in the geographic region and in the additional geographic region. Subsequently, the order fulfillment engine 206 leverages the clusters of geographic regions to assess effects of different parameters on order fulfillment by specifying different parameters for different clusters and evaluating order fulfillment in the different clusters when the different parameters are used. This allows the order fulfillment engine 206 to apply common parameters to each geographic region in a cluster; as orders are fulfilled in geographic regions of a cluster with a threshold frequency, using the same parameters for geographic regions in the cluster recedes likelihoods of shoppers fulfilling orders in geographic regions with different parameters, which increases a complexity of evaluating how different parameters affect order fulfillment.

FIG. 4 shows an example graph 400 identifying geographic regions generated by the modeling engine 216. A node of the graph 400 corresponds to geographic region 405, which includes one or more locations where the online concierge system 102 is capable of fulfilling orders received from users. The graph 400 associates a weight 410 with the geographic region 405 based on a number of shoppers who fulfilled at least one order to a location within geographic region 405 within a time interval. In various embodiments, the modeling engine 216 retrieves information describing orders completed by shoppers from the transaction records database 208. Information in the transaction records database 208 includes an identifier of an order, a time when the order was fulfilled, an identifier of a shopper who fulfilled the order, and a location where the order was fulfilled. The modeling engine 216 identifies orders fulfilled during the time interval; for each identified order, the modeling engine 216 determines a geographic region including a location where an identified order was fulfilled. The online concierge system 102 determines a number of unique identifiers of shoppers associated with geographic region 405 and determines the weight 410 for geographic region 405 based on the number of unique identifiers of shoppers associated with geographic region 405. In various embodiments, weight 410 is the number of unique identifiers of shoppers associated with geographic region 405, allowing the weight 410 to identify the number of shoppers who fulfilled at least one order within geographic region 405 during the time interval.

Similarly, graph 400 includes a node corresponding to geographic region 425 and weight 430 associated with geographic region 425. Weight 430 is determined from a number of shoppers who fulfilled at least one order within geographic region 425, as further described above. As geographic regions may be near each other, one or more shoppers may fulfill orders in different geographic regions during the time interval. This spillover of order fulfillment in different geographic regions during the time interval can impair the online concierge system 102 from evaluating effects of different parameters on order fulfillment by shoppers. For example, the online concierge system 102 applies different parameters for fulfilling orders identifying geographic region 405 and to fulfilling orders identifying geographic region 425. Comparison of order fulfillment information (e.g., time to fulfillment, compensation to shoppers, amount of distance traveled by shoppers, etc.) for geographic region 405 and geographic region 425 allows the online concierge system 102 to assess relative effects of the different parameters of order fulfillment. However, shoppers who fulfill orders in both geographic region 405 and geographic region 425 cause those shoppers fulfilling orders in geographic region 405 and in geographic region 425 to be affected by both parameters for geographic region 405 and for geographic region 425. Such order fulfillment subject to different parameters increases complexity of the online concierge system 102 determining how different parameters impact order fulfillment.

To allow more accurate evaluation of how parameters impact order fulfillment, the online concierge system 102 generates a connection 415 between geographic region 405 and geographic region 425 in response to at least one shopper fulfilling an order in geographic region 405 and fulfilling an order in geographic region 425. The connection 415 allows the online concierge system 102 to store information indicating that one or more shoppers fulfilled orders in both geographic region 405 and geographic region 425 during the time interval. Additionally, the connection 415 has a weight 420 that the online concierge system 102 determines from a number of shoppers who fulfilled orders in both geographic region 405 and geographic region 425. To determine the weight 420 of the connection 415, from information in the transaction records database 208, the online concierge system 102 determines a number of unique shoppers for which stored information indicates the shoppers fulfilled an order in geographic region 405 and fulfilled an order in geographic region 415 during the time interval. In some embodiments, the weight 420 of the connection 415 is a ratio of a number of shoppers who fulfilled at least one order in both geographic region 405 and geographic region 425 during the time interval and weight 410 of geographic region 405 or weight 430 of geographic region 425. For example, the online concierge system 102 determines a minimum of weight 410 and weight 430 and determines the weigh 415 of the connection as a ratio of the number of shoppers who fulfilled at least one order in both geographic region 405 and geographic region 425 during the time interval and the minimum of weight 410 and weight 430. Hence, the weight 415 of connection 420 provides a relative measure of a number of shoppers who fulfilled one or more orders in both geographic region 405 and geographic region 425 during the time interval to a number of shoppers who fulfilled orders in one of geographic region 405 or geographic region 425 during the time interval.

In the example of FIG. 4, graph 400 includes a node corresponding to geographic region 445 and weight 450 associated with geographic region 445. Weight 450 is determined from a number of shoppers who fulfilled at least one order within geographic region 445 during the time interval, as further described above. For purposes of illustration, FIG. 4 shows connection 435 between geographic region 405 and geographic region 445, indicating that one or more shoppers have fulfilled orders in geographic region 405 and in geographic region 445 during the time interval. Connection 435 has weight 440, determined as further described above, based on a number of shoppers who fulfilled one or more orders in both geographic region 405 and in geographic region 445 during time interval.

Additionally, example graph 400 shown in FIG. 4 includes a node corresponding to geographic region 455 and weight 460 associated with geographic region 455. As further described above, weight 460 is determined from a number of shoppers who fulfilled at least one order within geographic region 445 during the time interval. In the example of FIG. 4, geographic region 455 is not connected to geographic region 405, to geographic region 425, or to geographic region 445. This indicates that no shoppers fulfilled an order in geographic region 455 during the time interval and also fulfilled at least one order in geographic region 405, in geographic region 425, or in geographic region 445 during the time interval. Hence, the graph 400 includes a connection between a pair of geographic regions when one or more shoppers fulfilled at least one order in both geographic regions of the pair during the time interval and does not include a connection between the pair of geographic regions when no shoppers fulfilled at least one order in both geographic regions of the pair.

### Customer Mobile Application

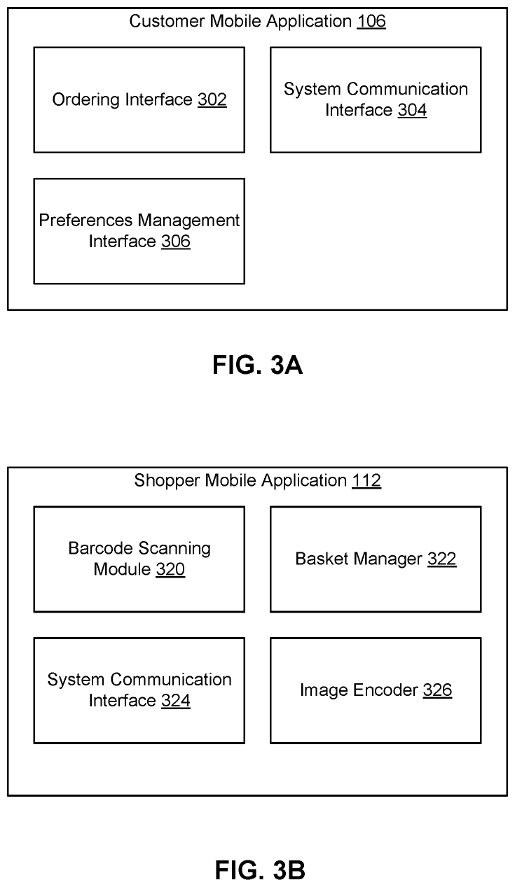

FIG. 3A is a diagram of the customer mobile application (CMA) 106, according to one embodiment. The CMA 106 includes an ordering interface 302, which provides an interactive interface with which the customer 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Generating Clusters of Geographic Regions Based on Activity of Shoppers in Different Geographic Regions

FIG. 5 is a flowchart of one embodiment of a method for generating one or more clusters of geographic regions based on fulfillment of orders by shoppers in different geographic regions. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online concierge system 102 in various embodiments.

The online concierge system 102 identifies 505 multiple geographic regions, with each geographic region including one or more locations. In various embodiments, the online concierge system 102 identifies 505 a geographic region based on a location, with a geographic region including points within a threshold distance of a location. In some embodiments, each geographic region corresponds to a ZIP code. The online concierge system 102 may identify 505 geographic regions using any suitable method in various embodiments.

As the online concierge system 102 receives orders from users, shoppers fulfill the received orders. A shopper fulfills an order by obtaining one or more items included in an order from a warehouse 110 and delivering the one or more items to a location identified by the order. When a shopper fulfills an order, the online concierge system 102 stores information identifying a time when the shopper fulfilled the order and a location identified by the order in association with an identifier of the order and an identifier of the shopper. The online concierge system 102 may store any additional information in association with the identifier of the order and the identifier of the shopper, in various embodiments.

From the stored information identifying fulfillment of orders by shoppers, the online concierge system 102 identifies 510 one or more geographic region in which a shopper fulfilled orders during a time interval. In various embodiments, the time interval is a threshold amount of time prior to a current time, while in other embodiments, the time interval is any suitable duration identified by the online concierge system. For example, the online concierge system 102 selects a geographic region and identifies 510 shoppers for whom information is stored indicating a shopper fulfilled at least one order having a location within the selected geographic region. As another example, the online concierge system 102 determines a geographic region including a location of each order fulfilled during the time interval and stores the determined geographic region for an order in association with the shopper who fulfilled the order. In some embodiments, the online concierge system 102 determines a location of a shopper from location information the online concierge system 102 receives from a client device of the user within a threshold amount of time from a time when the shopper indicated an order was fulfilled and identifies 510 the geographic location including the location information received from the client device of the user in association with the order and the time when the shoppers indicated the order was fulfilled. For example, the online concierge system 102 receives location information from one or more position sensors (e.g., a global positioning system sensor) included in the client device of the shopper. This allows the online concierge system 102 to identify 510 a geographic region for each order fulfilled by a shopper during the time interval, allowing the online concierge system 102.

From the identified geographic regions in which orders were fulfilled during the time interval, the online concierge system 102 generates 515 a graph having nodes corresponding to geographic regions, as further described above in conjunction with FIG. 4. In various embodiment, each node in the graph corresponds to a different geographic region and each note has a weight based on a number of shoppers who fulfilled an order in a geographic region corresponding to a node. For example, a node corresponding to a geographic region includes an identifier of the geographic region and a number of shoppers who fulfilled at least one order in the geographic region during the time interval. To determine the weight for a geographic region, the online concierge system 102 identifies orders fulfilled during the time interval for which the geographic region was identified 510 and determines a number of shoppers associated with orders including a location included in the geographic region and fulfilled during the time interval. In various embodiments, the online concierge system 102 determines a number of unique shoppers who fulfilled at least one order having a location included in the geographic region during the time interval.

Additionally, the online concierge system 102 generates connections in the graph between a node corresponding to a geographic region and an additional node corresponding to an additional geographic region in response to one or more shoppers fulfilling orders in the geographic region and in the additional geographic region during the time interval. A connection between the node corresponding to the geographic region and the additional node corresponding to the additional geographic region. Additionally, the connection between the node corresponding to the geographic region and the node corresponding to the additional geographic region has a weight determined from a number of shoppers who fulfilled at least one order in the geographic region during the time interval and fulfilled at least one order in the additional geographic region during the time interval. For example, the weight of a connection between the node corresponding to the geographic region and the additional node corresponding to the additional geographic region is a ratio of a number of unique shoppers who fulfilled at least one order in the geographic region during the time interval and fulfilled at least one order in the additional geographic region to a weight of the node or of the additional node. In an example, the weight of a connection between the node corresponding to the geographic region and the additional node corresponding to the additional geographic region is a ratio of a number of unique shoppers who fulfilled at least one order in the geographic region during the time interval and a minimum of the weight of the node and the weight of the additional node. Hence, the graph includes connections between a pair of nodes in response to one or more shoppers fulfilling orders during the time interval in geographic regions corresponding to each node of the pair. If no shoppers have fulfilled orders in a geographic region and in an additional geographic region, the graph does not include a connection between a node corresponding to the geographic region and an additional node corresponding to the additional geographic region. Hence, the weight of a connection between a node and an additional node provides a measure of an amount of shoppers who fulfilled orders in geographic regions corresponding to both the node and the additional node during the time interval, allowing the weight of the connection to provide a measure of overlapping shoppers who fulfilling orders in multiple different geographic regions during the time interval.

The online concierge system 102 selects 520 a pair of geographic regions and determines 525 whether a weight of a connection between the pair of nodes corresponding to the pair of geographic regions equals or exceeds a threshold value. As the weight of the connection between a node corresponding to a geographic region and an additional node corresponding to an additional geographic region is based on a number or shoppers who fulfilled at least one order in both the geographic region and in the additional geographic region during the time interval, the threshold value allows the online concierge system 102 to specify an amount of overlap of shoppers fulfilling orders in both the geographic region and the additional geographic region. For example, the threshold value specifies a percentage of shoppers who fulfilled orders in both the geographic region and the additional geographic region during the time interval. Higher threshold values correspond to a greater percentage of shoppers fulfilling orders in both the geographic region and the additional geographic region during the time interval.

In response to determining 525 the weight of the connection between the pair of nodes corresponding to the pair of geographic regions equaling or exceeding the threshold value, the online concierge system 102 generates 530 a cluster of geographic regions that includes the pair of nodes. The pair of nodes includes a node corresponding to a geographic region of the pair and an additional geographic region of the pair, so the cluster of geographic regions includes the geographic region and the additional geographic region in response to the connection between the node corresponding to the geographic region and the additional node corresponding to the additional geographic region. Hence, the cluster of geographic regions includes geographic regions where at least a threshold percentage of shoppers fulfilled orders in different geographic locations in the cluster during the time interval.

However, in response to determining 525 the weight of the connection between the pair of nodes corresponding to the pair of geographic regions equaling or exceeding the threshold value, the online concierge system 102, the online concierge system 102 generates 525 a separate cluster for each geographic region of the pair. Hence, when the weight of a connection between a node corresponding to a geographic region and an additional node corresponding to an additional geographic region is less than the threshold value, the online concierge system 102 generates a cluster including the geographic region and a separate cluster including the additional geographic region. This allows the online concierge system 102 to separate the geographic region and the additional geographic region when less than a threshold percentage of shoppers fulfilling orders during the time interval fulfill orders in both the geographic region and in the additional geographic region.

Referring to FIG. 4, in an example, weight 420 of the connection 415 between geographic region 405 and geographic region 425 equals or exceeds the threshold value, so the online concierge system generates 530 a cluster including geographic region 405 and geographic region. Subsequently, if the online concierge system 102 selects the cluster, one or more parameters for the cluster specified by the online concierge system 102 are applied to both geographic region 405 and geographic region 425. As weight 420 equaled or exceeded the threshold value, a sufficient percentage of shoppers fulfill orders in both geographic region 405 and geographic region 425 during the time interval that the online concierge system 102 applies common parameters to geographic region 405 and geographic region 425 to reduce a number of shoppers fulfilling orders in geographic regions with different parameters. In an additional example, weight 440 of the connection 435 between geographic region 405 and geographic region 445 is less than the threshold value, so the online concierge system 102 generates 535 a cluster including geographic region 405 and another cluster including geographic region 445. As weight 440 is less than the threshold value in this example, less than a threshold percentage of shoppers fulfill orders in both geographic region 405 and geographic region 445 during a time interval, so using separate parameters for geographic region 405 and geographic region 445 results in less than a threshold percentage of shoppers fulfilling orders in geographic regions with different parameters.

Subsequently, when the online concierge system 102 identifies geographic regions for testing modified parameters for operation, the online concierge system 102 uses the generated clusters. The online concierge system 102 selects a set of parameters and applies the set of parameters to each geographic region included in a cluster selected by the online concierge system, so fulfillment of orders subsequently received by the online concierge system 102 that identify locations within the cluster are subject to the set of parameters. Hence, parameters for a cluster are applied to each geographic region in the cluster. An alternative set of parameters is applied to geographic regions that are not included in the cluster (i.e., geographic regions “outside” of the cluster). As generation of the clusters accounts for an amount of shoppers who fulfilled orders in multiple geographic regions during a time interval, specifying common parameters for each geographic region in a cluster allows the online concierge system 102 to account for spillover of shoppers across different geographic regions by having common parameters apply to each geographic region in which shoppers are likely to fulfill orders. This mitigates effects on parameter evaluation by the online concierge system 102 caused by shoppers fulfilling orders in geographic regions with different parameters, allowing the online concierge system 102 to more accurately evaluate the set of parameters and the alternative set of parameters by minimizing spillover of shoppers fulfilling orders in geographic regions subject to the set of parameters and subject to the alternative set of parameters. Additionally, the online concierge system 102 may specify the threshold value to maximize a number of clusters that are generated, which decreases the amount of time for the online concierge system 102 to evaluate performance of different parameters in different geographic regions. This allows the generation of clusters to conserve computational resources of the online concierge system 102 used for maintaining different parameters and accounting for the different parameters when fulfilling orders received from users. Hence, in addition to improving accuracy for evaluating effects of different parameters on order fulfillment, generating clusters of geographic regions allows the online concierge system 102 to reduce an amount of time the online concierge system 102 maintains and selects between different parameters to evaluate effects of different parameters on order fulfillment.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying a plurality of geographic regions by an online concierge system, each geographic region including one or more locations for fulfilling orders received by the online concierge system;
retrieving previously received orders that were fulfilled by shoppers via the online concierge system during a time interval;
identifying geographic regions including locations in which the previously received orders were fulfilled by shoppers;
generating a graph including geographic regions by:
identifying a geographic region and identifying a number of shoppers who fulfilled at least one order in the geographic region during the time interval;
creating a connection between the geographic region and an additional geographic region in response to one or more shoppers fulfilling at least one order in the geographic region and in the additional geographic region during the time interval; and
computing a weight for the connection based on a number of shoppers fulfilling at least one order in the geographic region and in the additional geographic region during the time interval;
selecting a pair of geographic regions including the geographic region and the additional geographic region; and
generating a cluster including the region and the additional geographic region in response to the weight of the connection between the region and the additional geographic region equaling or exceeding a threshold value.

2. The method of claim 1, wherein the weight of the connection between the geographic region and the additional geographic region comprises a ratio of the number of shoppers fulfilling at least one order in the geographic region and in the additional geographic region during the time interval and a number of shoppers fulfilling at least one order in the geographic region or in the additional geographic region during the time interval.

3. The method of claim 2, wherein the weight of the connection between the geographic region and the additional geographic region comprises a ratio of the number of shoppers fulfilling at least one order in the geographic region and in the additional geographic region during the time interval and a minimum of a number of shoppers fulfilling at least one order in the geographic region during the time interval and a number of shoppers fulfilling at least one order in the additional geographic region during the time interval.

4. The method of claim 1, further comprising:
generating separate clusters for the region and the additional geographic region in response to the weight of the connection between the region and the additional geographic region being less than the threshold value.

5. The method of claim 1, wherein a geographic region in which a shopper previously fulfilled a previously received order is determined from location information the online concierge system received from a client device of the shopper within a threshold amount of time of the shopper indicating the previously received order was fulfilled.

6. The method of claim 5, wherein the online concierge system receives the location information from a position sensor included in the client device of the shopper.

7. The method of claim 1, further comprising:
selecting a set of parameters for order fulfillment; and
applying the set of parameters to the cluster so subsequently received orders including locations in the geographic region or in the additional geographic region are fulfilled subject to the set of parameters.

8. The method of claim 7, further comprising:
applying an alternative set of parameters to one or more geographic regions outside of the cluster.

9. A computer program product comprising a non-transitory computer readable storage medium having instructions encoded thereon that, when executed by a processor, cause the processor to:
identify a plurality of geographic regions by an online concierge system, each geographic region including one or more locations for fulfilling orders received by the online concierge system;
retrieve previously received orders that were fulfilled by shoppers via the online concierge system during a time interval;
identify geographic regions including locations in which the previously received orders were fulfilled by shoppers;
generate a graph including geographic regions by:
identifying a geographic region and identifying a number of shoppers who fulfilled at least one order in the geographic region during the time interval;
creating a connection between the geographic region and an additional geographic region in response to one or more shoppers fulfilling at least one order in the geographic region and in the additional geographic region during the time interval; and
computing a weight for the connection based on a number of shoppers fulfilling at least one order in the geographic region and in the additional geographic region during the time interval;
select a pair of geographic regions including the geographic region and the additional geographic region; and
generate a cluster including the region and the additional geographic region in response to the weight of the connection between the region and the additional geographic region equaling or exceeding a threshold value.

10. The computer program product of claim 9, wherein the weight of the connection between the geographic region and the additional geographic region comprises a ratio of the number of shoppers fulfilling at least one order in the geographic region and in the additional geographic region during the time interval and a number of shoppers fulfilling at least one order in the geographic region or in the additional geographic region during the time interval.

11. The computer program product of claim 10, wherein the weight of the connection between the geographic region and the additional geographic region comprises a ratio of the number of shoppers fulfilling at least one order in the geographic region and in the additional geographic region during the time interval and a minimum of a number of shoppers fulfilling at least one order in the geographic region during the time interval and a number of shoppers fulfilling at least one order in the additional geographic region during the time interval.

12. The computer program product of claim 9, wherein the non-transitory computer readable storage medium further has instructions encoded thereon that, when executed by the processor, cause the processor to:
generate separate clusters for the region and the additional geographic region in response to the weight of the connection between the region and the additional geographic region being less than the threshold value.

13. The computer program product of claim 9, wherein a geographic region in which a shopper previously fulfilled a previously received order is determined from location information the online concierge system received from a client device of the shopper within a threshold amount of time of the shopper indicating the previously received order was fulfilled.

14. The computer program product of claim 13, wherein the online concierge system receives the location information from a position sensor included in the client device of the shopper.

15. The computer program product of claim 9, wherein the non-transitory computer readable storage medium further has instructions encoded thereon that, when executed by the processor, cause the processor to:
select a set of parameters for order fulfillment; and
apply the set of parameters to the cluster so subsequently received orders including locations in the geographic region or in the additional geographic region are fulfilled subject to the set of parameters.

16. The method of claim 15 wherein the non-transitory computer readable storage medium further has instructions encoded thereon that, when executed by the processor, cause the processor to:
apply an alternative set of parameters to one or more geographic regions outside of the cluster.
